(19) United States
(12) Patent Application Publication
(10) Pub. No.: US 2026/0105173 A1
(43) Pub. Date: Apr. 16, 2026

(54) STORAGE ENVIRONMENT ACCESS PERMISSION NORMALIZATION

(71) Applicant: Rubrik, Inc., Palo Alto, CA (US)

(72) Inventors: Aviv Ghilai, Tel Aviv (IL); Ran Pollak, Jerusalem (IL); Tomer Gershi, Tel Aviv (IL); Max Goren, Tel Aviv (IL)

(21) Appl. No.: 18/916,401

(22) Filed: Oct. 15, 2024

(51) Int. Cl. G06F 21/62; H04L 9/40

(52) U.S. Cl. CPC G06F 21/6218; G06F 21/604; H04L 63/101; H04L 63/102; G06F 3/0604

(57) ABSTRACT

Methods, systems, and devices for data management are described. A data management system may obtain a set of access information sources include access permission information for one or more principal accounts to access one or more files in a storage environment. The DMS may convert the set of access information sources to one or more permission sets each having a same format. The DMS may select one or more valid permission sets from among the one or more permission sets based on respective owner accounts associated with the one or more files, based on the one or more permission sets, and based on the one or more principal accounts. The DMS may generate, based on the one or more valid permission sets, a listing that indicates, for the one or more files, respective sets of principal accounts and associated respective access permission levels.

### FIELD OF TECHNOLOGY

The present disclosure relates generally to data management, including techniques for storage environment access permission normalization.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports storage environment access permission normalization in accordance with aspects of the present disclosure.

FIG. 2 shows an example of a system diagram that supports storage environment access permission normalization in accordance with aspects of the present disclosure.

FIG. 3 shows an example of a listing that supports storage environment access permission normalization in accordance with aspects of the present disclosure.

FIG. 4 shows an example of a process flow that supports storage environment access permission normalization in accordance with aspects of the present disclosure.

FIG. 5 shows a block diagram of an apparatus that supports storage environment access permission normalization in accordance with aspects of the present disclosure.

FIG. 6 shows a block diagram of a permission component that supports storage environment access permission normalization in accordance with aspects of the present disclosure.

FIG. 7 shows a diagram of a system including a device that supports storage environment access permission normalization in accordance with aspects of the present disclosure.

FIGS. 8 through 10 show flowcharts illustrating methods that support storage environment access permission normalization in accordance with aspects of the present disclosure.

### DETAILED DESCRIPTION

A data management system (DMS) may manage storage of files in a storage environment (e.g., an), and the storage environment may include sources of access information in various formats (e.g., identity-based access information, resource-based access information, or organization-wide based access information). The access information sources may define which principal accounts (e.g., principal account may be a user account, a group, a group of accounts, a group of user accounts, a service, or an organization) are allowed to access or modify a set of files stored at the storage environment (e.g., for an organization). The DMS may identify an access permission of a principal account when the principal account attempts to access a file. For example, the DMS may iterate through the set of access information sources as part of an access permission flow. The access permission flow may evaluate each access information source for the principal account and the file. The interactions between the access permission sources for the principal account and the file may be relatively complex given the various types of access information sources involved. Given the complexity of the different access information sources for a storage environment, an administrative user of the DMS may be unaware of which principal accounts have access to which files on the storage environment.

According to techniques described herein, a DMS may generate a listing for files at a storage environment that indicates respective access permissions for one or more principal accounts of the storage environment. Based on the list, the DMS may display, for example, to an administrative user of the DMS, which principal accounts of the storage environment have access to which files in the storage environment given the set of access information sources. To generate the list, the DMS may retrieve the set of access information sources for one or more principal accounts for one or more files in the storage environment. The DMS may convert the set of access information sources into one or more permission sets that have a same format (e.g., a unified or consistent format). For example, a permission set may be a common structure for holding permissions information.

The DMS may identify which permissions sets of the generated permission sets are valid permission sets. For example, the DMS may identify which permission sets are valid based on comparing the permissions granted across the various permission sets and their mutual effect on each other. For example, the DMS may identify and resolve contradicting permission sets and may merge repeated permission sets.

Based on the valid permission sets, the DMS may generate the list of access permissions. The list may indicate, for each resource in the storage environment (e.g., each file or set of files), which principal accounts have access to the resource and the type of access the principal accounts have (e.g., read-only, write-only, or read-write). The DMS may display the list of access permissions to an administrative user. In some examples, the list of access permissions may identify respective access permissions granted to the one or more principal accounts (e.g., as determined automatically by the DMS based on the set of access information sources and the access permission flow). The administrative user may utilize the one or more access paths to view which principal accounts have access to which files on a given storage environment. For example, an administrative user may identify the respective access permissions granted to the one or more principal accounts based on viewing the list of access permissions. The administrative user may update the permissions via the storage environment, and the DMS may display a list of one or more access path permissions based on the updated permissions.

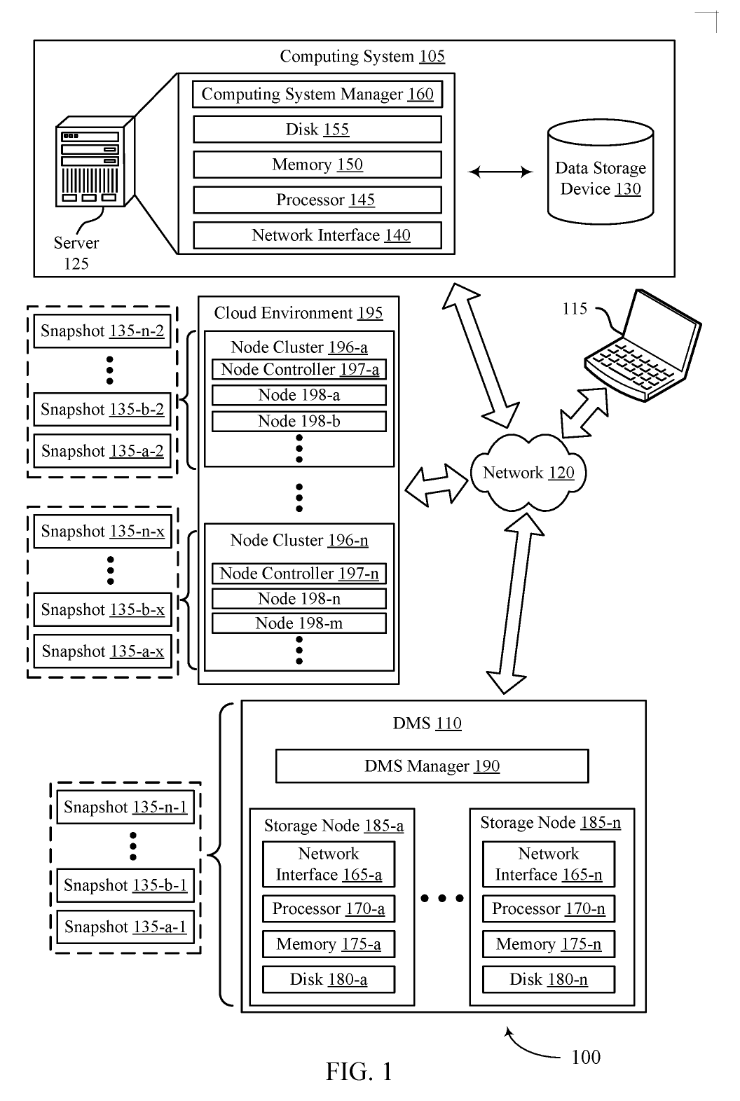

FIG. 1 illustrates an example of a computing environment 100 that supports storage environment access permission normalization in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructureas-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. In some cases, a computing object that is the subject of a snapshot 135 may be or include a collection of multiple objects (e.g., computing objects may have hierarchical relationships, with lower-level computing objects included within one or more higher-level computing objects). For example, a filesystem may include multiple files, and along with the filesystem being a computing object, the files therein may also be computing objects. Or, as another example, a database may include multiple tables, and along with the database being a computing object, the tables therein may also be computing objects. Thus, a snapshot may be of one or more computing objects, and a snapshot of a first computing object (e.g., a higher-level computing object) may also be a snapshot of each computing object (e.g., each lower-level computing object) that is included in (e.g., is a member or component of) the first computing object. Additionally, a snapshot may be of one or more lower-level computing objects individually (e.g., a snapshot of a lower-level computing object may be separate from another snapshot of another lower-level computing object, separate from another snapshot of a higher-level computing object that contains the lower-level computing object, or both).

A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. A base snapshot 135 may alternatively be referred to as a full snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a base snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a base snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services (AWS)). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on AWS. In another example, multiple separate node clusters 196 for multiple different customers or tenants may be hosted on Microsoft Azure. Separating each customer or tenant’s data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

According to techniques described herein, the DMS 110 may generate a listing for files or resources at a storage environment (e.g., a cloud environment 195 or a storage node 185) that indicates respective access permissions for the files or resources for one or more principal accounts of the storage environment. For example, the storage environment may be an AWS environment. Based on the listing, the DMS 110 may display (e.g., via a computing devices 115 and to an administrative user of the DMS 110) which principal accounts of the storage environment have access to which files in the storage environment given the set of access information sources. To generate the list, the DMS 110 may retrieve the set of access information sources for one or more principal accounts to access one or more files or resources in the storage environment. The DMS 110 may convert the set of access information sources into one or more permission sets that have a same format (e.g., a unified or consistent format).

The DMS 110 may identify which permissions sets of the generated permission sets are valid permission sets. For example, the DMS 110 may identify which permission sets are valid based on comparing the permissions granted across the various permission sets and their mutual effect on each other. For example, the DMS 110 may identify and resolve contradicting permission sets and may merge repeated permission sets.

Based on the valid permission sets, the DMS 110 may generate the list of access permissions. The list may indicate for each resource in the storage environment (e.g., each file or set of files), which principal accounts have access to the resource and the type of access the principal accounts have (e.g., read-only, write-only, or read-write). The DMS 110 may display the list of access permissions to an administrative user. The administrative user may utilize the one or more access paths to determine which principal accounts have access to which files on a given storage environment. The administrative user may update the permissions via the storage environment, and the DMS 110 may display a list of one or more access path permissions based on the updated permissions.

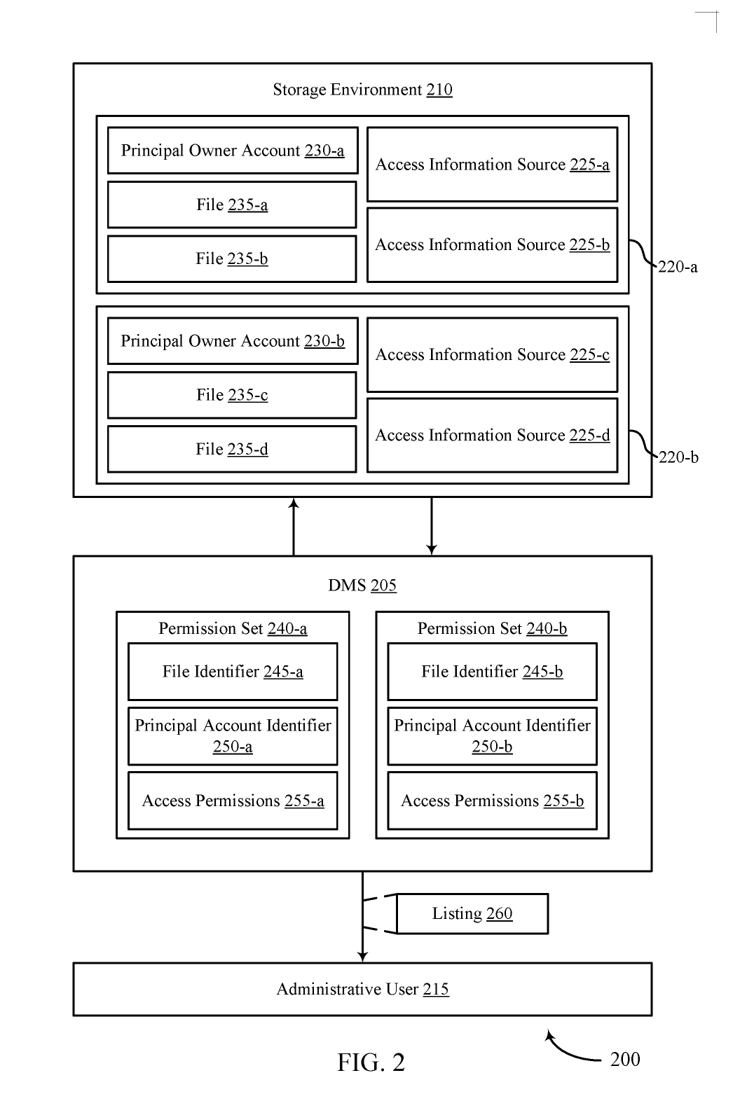

FIG. 2 shows an example of a system diagram 200 that supports storage environment access permission normalization in accordance with aspects of the present disclosure. The system diagram 200 may implement or be implemented by aspects of the computing environment 100 described with reference to FIG. 1. For example, the system diagram 200 may include a DMS 205, which may represent an example of a DMS 110 as described with reference to FIG. 1. The DMS 205 may include or communicate with a storage environment 210. The storage environment 210 may be an example of a storage node 185-a or a cloud environment 195, as described with reference to FIG. 1. The storage environment 210 may include a first resource set 220-a. The first resource set 220-a may be owned by (e.g., controlled by) a first principal owner account 230-a. The first set of resources may include a first file 235-a and a second file 235-b. Although shown as two files 235, a set of resources may include any quantity of files (e.g., hundreds, thousands, or millions of files). The first resource set 220-a may include a first access information source 225-a and a second access information source 225-b. Although shown as two access information sources 225, a resource set may include any quantity of access information sources. Additionally, or alternatively, the storage environment 210 may include a second resource set 220-b. The second resource set 220-b may be owned by (e.g., controlled by) a second principal owner account 230-b. The second resource set 220-b may include a third file 235-c and a fourth file 235-d. The second resource set 220-b may include a third access information source 225-c and a fourth access information source 225-d.

The DMS 205 may identify an access permission of a principal account when the principal account attempts to access a resource stored in the storage environment 210 (e.g., a file 235). For example, the DMS 205 may iterate through a set of access information sources 225 as part of an access permission flow. The access permission flow may evaluate each access information source 225 for the principal account and the resource.

For example, the DMS 205 may analyze the principal account (e.g., user) access permissions for the resources in the storage environment 210 (e.g., AWS resources). The analysis may be inherently complex. In some examples, the DMS 205 may analyze policies from various access information sources 225. The access information sources 225 may include resource-based policies, identity-based policies, and organization-level policies. For example, a resource-based policy may indicate which principal accounts are allowed access (as well as the access type) to a specific resource or group of resources. As another example, an identity-based policy may indicate which resources or groups of resources a specific principal account is allowed to access as well as the access type. Organization-level policies may indicate which resources or groups of resources groups of principal accounts are allowed to access as well as the access type. In some examples, the access information may include file permissions such as S3 file permissions or S3 bucket or object permissions. The file permissions for a resource or a file 235 may include additional sets of permissions based on access control list (ACL) information associated with the file 235 and a principal owner account 230 of the file 235. In some examples, the DMS 205 may identify access permissions based on an access evaluation complexity. For example, the DMS 205 may evaluate in-account access (e.g., a principal account accessing resources owned by the principal account versus cross-account (e.g., a first principal account accessing resources owned by a second principal account). Evaluating the access permissions may involve complicated calculations during evaluation, which may be time consuming at the DMS 205. In some examples, the DMS 205 may analyze policy conditions. A statement included in a policy may indicate various conditions related to a requested resource, a requesting identity, or a request context.

It may be beneficial for an administrative user to have access to a listing of which principal accounts have access to which resources. Iterating through the set of access information sources 225, as part of an access permission flow, for each resource may be computationally demanding, and an associated processing time may be relatively large. To keeping the listing updated, the DMS 205 may iterate through the set of access information sources 225 again based on an update to an access permission in the set of access permissions.

According to techniques described herein, the DMS 205 may provide a comprehensive view of sensitive data access permissions (e.g., a listing 260 of data access permissions). The listing 260 may detail who (e.g., which principal accounts) inside an organization and outside the organization may access sensitive data in the storage environment 210 (e.g., may access which AWS resources). The DMS 205 may include a normalization engine. The normalization engine may utilize relevant access data (e.g., access information sources 225) and may process the relevant access data into a unified format. The DMS 205 may efficiently analyze and display (e.g., present) access information in a listing to an administrative user. For example, the normalization engine may decrease a process time associated with generating a listing of access permissions. The administrative user 215 may have a clear and accurate understanding of principal account access permissions across the storage environment (e.g., AWS environment) based on the listing.

A normalized structure, which may be referred to as an access path permission, may represent a normalized statement indicating a first principal account (e.g., entity X) and a first access permission (e.g., is allowed or denied access) to a resource (e.g., resource Y).

The normalization engine may transform access data (e.g., the access data included in the storage environment 210), from multiple sources (e.g., access information sources 225), to a list of normalized statements, which may be referred to as an access path permission. Each access path permission may include two parts: a predicate and a statement. The predicate may include a resource name (e.g., an Amazon resource name (ARN)) associated with one or more resources that the access permission applies to. The predicate may include additional information about one or more resources (e.g., the files 235) involved. The statement may include information about which principal accounts may access the one or more resource and in what manner (e.g., read-only, write-only, or read-write). Using the list of access path permissions and a resource (e.g., an S3 file 235), the DMS 205 may gather or obtain access path permissions with predicates that match the resource (e.g., file 235). The DMS 205 may calculate the list of principal accounts that may access the resource based on the access path permissions.

Generation of the listing 260 may involve three stages. The DMS 205 may, in a first stage, convert each of the access information sources (e.g., policies, ACLs) to a list of raw structures of a unified format, which may be referred to as a permission sets 240. For example, each permission set 240 may be in the predicate-statement format described herein. For example, the DMS 205 may convert a first access information source 225-a into a first permission set 240-a. At a second stage, the permission sets 240 may be normalized to contain the relevant permission sets 240. For example, the DMS 205 may delete or merge permission sets 240 as part of the normalization process, such that the access granted by the permission sets 240 is valid. For example, the DMS 205 may covert a second access information source 225-b into an irrelevant permission set 240. The DMS 205 may remove the irrelevant permission set for a generation of the access path permissions.

At a third stage, the DMS 205 may expand the valid permission sets (e.g., a first permission set 240-a and the second permission set 240-b) to a list of simplified access path permissions. The DMS 205 may evaluate the access path permissions to determine an access permission for a specific resource. Accordingly, the DMS 205 may generate the listing 260 based on the list of access path permissions.

As described herein, an access path permission structure may include a predicate and a statement. The predicate may include a data asset identifier (e.g., a resource number or an ARN (e.g., S3 bucket ARN) and a path pattern (e.g., a regular expression (regex) pattern). Files 235 with file paths that match the path pattern may be affected by the access path permission. In some examples, the predicate may include an ACL identifier (e.g., an internal identifier that represents a set of ACL grants). Files 235 with an ACL grant in the set of ACL grants may be affected by the access path permission. The predicate may include an owner identifier (e.g., a principal owner account identifier). Files 235 that are owned by a principal owner account 230 may be affected by the access path permission.

The statement of an access path permission may include an access permission (e.g., either ALLOW or DENY), and an access type or action (e.g., READ access, WRITE access, or READ & WRITE access). The statement may include a principal account identifier associated with a principal account for which the access permission and access type apply. The principal account may be an internal entity (e.g., AWS entity) to an organization or an external entity to an organization. The principal account identifier may indicate the access permission and access type are public (e.g., PUBLIC), and apply to all principal accounts.

A permission set structure may be similar to the access path permission structure. For example, a first permission set 240-a may include a file identifier 245-a (e.g., data asset identifier, path pattern, or ACL identifier, as described herein) indicating one or more files 235 (e.g., the first file 235-a and the second file 235-b) and access permissions 255-a for the one or more files 235. The first permission set 240-a may include an owner identifier indicating a principal owner account 230 of the one or more files 235 (e.g., the first principal owner account 230-a). The first permission set 240-a may include a principal account identifier 250-a indicating one or more principal accounts affected by the first permission set 240-a. The second permission set 240-b may include a second file identifier 245-b, a second access permissions 255-b, a second owner identifier, and a second principal account identifier 250-b.

Additionally, or alternatively, the permission set 240 may include raw information about the permission, originating from an identify and access management (IAM) policy or an ACL. For example, the predicate of the permission set 240 may be more complex (e.g., include more information) than the predicate of an access path permission. The predicate of a permissions set 240 may include a resource pattern (e.g., a regex pattern). Files 235 (e.g., data assets or resources) that match the resource pattern may be affected by the permission set 240. For example, the DMS 205 may perform file matching based on a regular expression of a path, a principal owner account 230 of a file 235, or ACL associated with a file 235.

The predicate of the permission set 240 may include a set of filters that may be passed for the permission set to apply (e.g., to make effective). A filter may be from a set of pre-defined supported filters included at the DMS 205. For example, the filters may check the resource (e.g., resource account, resource region), the principal account (e.g., principal organization, principal tag) or the request context (e.g., source internet protocol (IP) address or secure transport).

As an illustrative example, at a first stage, the DMS 205 may convert access data to permission sets. The DMS 205 may iterate over: IAM resource-based policies, IAM identity-based policies (e.g., inline and managed), permission boundaries (e.g., AWS permission boundaries), organization-level policies (e.g., service control policies (SCP)), or file ACLs (e.g., in S3 buckets). Each statement or access permission in each policy may be normalized into one or more permission sets, such that each permission set 240 includes a single action, principal, and resource pattern. For example, the DMS 205 may iterate over each access information source 225 in a first resource set 220-a (e.g., a first access information source 225-a and a second access information source 225-b) and each access information source 225 in a second resource set 220-b (e.g., a third access information source 225-c and a fourth access information source 225-d). The DMS 205 may generate multiple permission sets 240 of a unified format.

At the second stage, the DMS 205 may normalize the permission sets 240 in accordance with the normalization engine. The DMS 205 may normalize the permission sets 240 based on an origin of each permission set and a mutual effect of the access permissions on each other.

When the DMS 205 analyzes a permission set 240 that grants same-account access (e.g., from a resource-based policy or identity-based policy), the DMS 205 may keep the permission set 240 and limit an effect of the permission set 240 to the principal account the permission set 240 is defined in. When the DMS 205 analyzes a permission set 240 that grants cross-account access (e.g., from a resource-based policy or ACL), the DMS 205 may attempt to merge the permission set 240 with other relevant permission set 240 from the foreign account to a unified permission set that considers the predicates of both permission sets 240.

In some examples, the DMS 205 may generate a first permission set 240-a based on the access information source 225-a. The access information source 225-a may grant the first principal owner account 230-a access to the first file 235-a (e.g., same account access). The DMS 205 may limit an effect of the first permission set 240-a to the first principal owner account 230-a the first permission set 240-a is defined in.

In some examples, the DMS 205 may generate a first permission set 240-a based on the access information source 225-a. The access information source 225-a may grant the first principal owner account 230-a access to the third file 235-c (e.g., cross account access). For example, the access information source 225-a may grant cross account access because the access information source 225-a is associated with the first resource set 220-a owned by the first principal owner account 230-a but grants access to a file in the second resource set 220-b owned by the second principal owner account 230-b. Since the first principal owner account 230-a is not an owner account of the third file 235-c, the first permission set 240-a alone may not be adequate to grant the first principal owner account 230-a access to the third file 235-c.

The DMS 205 may generate the second permission set 240-b based on the third access information source 225-c. The third access information source 225-c may grant the first principal owner account 230-a access to the third file 235-c. The first principal owner account 230-a may access the third file 235-c based on both the first permission set 240-a and the second permission set 240-b as the third access information source 225-c is associated with the second resource set 220-b and grants access to the third file 235-c within the second resource set 220-b (e.g., grants same-account access). The DMS 205 may merge the first permission set 240-a and the second permission set 240-b based on both granting access to the same file (e.g., the third file 235-c) and to the same principal account.

If the third access information source 225-c denies the first principal owner account 230-a access to the third file 235-c, the DMS 205 may not merge the first permission set 240-a and the second permission set 240-b. The DMS 205 may invalidate or remove the first permission set 240-a based on the second permission set 240-b denying the first principal owner account 230-a access to the third file 235-c.

The DMS 205 may separate the same-account and the cross-account normalization based on the storage environment 210 (e.g., AWS storage environment) having different evaluation logic for same-account access and cross-account access. For example, an IAM policy may grant different permissions (e.g., do different things) depending on whether the requested access is same-account access or cross-account access. The DMS 205 may separate the logic and analyze the same permission sets 240 twice (e.g., once for same-account access and once for cross-account access).

At the third stage, the DMS 205 may expand each permission set 240 to one or more access path permissions, such that each access path permission indicates (e.g., contains) a single resource (e.g., a single data asset instead of a resource pattern). The DMS 205 may evaluate the filters and eliminate the permission sets 240 that the filters do not pass (e.g., the filter conditions are not met).

The DMS 205 may output the listing 260 of the one or more access path permissions to an administrative user 215. The listing 260 may be based on the access path permissions. In some examples, the DMS 205 may cause display of the listing 260 via a user interface to the administrative user 215 (e.g., to a computing device 115 as described herein with reference to FIG. 1).

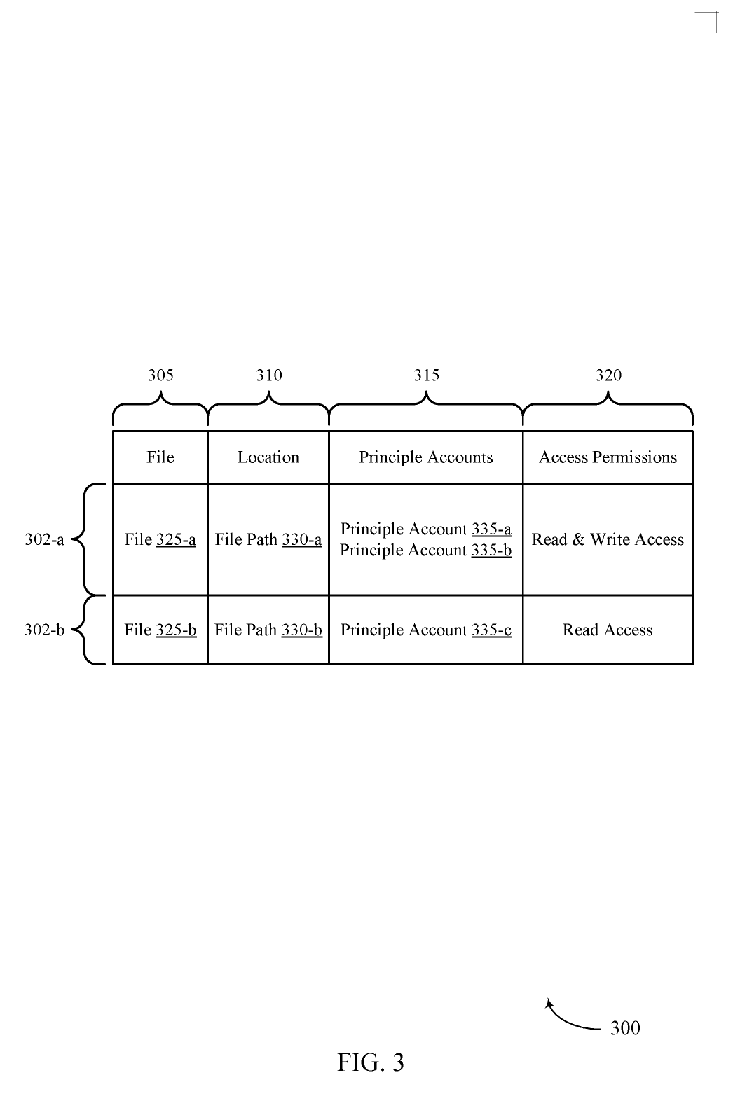

FIG. 3 shows an example of a listing 300 that supports storage environment access permission normalization in accordance with aspects of the present disclosure. The listing 300 may be generated by a DMS 110 or a DMS 205 as described herein with reference to FIGs. 1 and 2. The DMS may generate the listing 300 (e.g., the listing 260 as described with reference to FIG. 2) based on one or more access information sources. The DMS may output the listing 300 to an administrative user 215 (e.g., to a computing device associated with the administrative user 215). In some examples, the DMS may cause display of the listing 300 via a user interface to the administrative user.

For example, the listing 300 may include one or more access path permissions 302. For the access path permissions 302, the listing 300 may include a file 305 affected by the access path permissions 302, one or more locations 310 affected by the access path permission 302, one or more principal accounts 315 affected by the access path permission 302, or one or more access permissions 320.

A first access path permission 302-a may affect a first file 325-a, a first file path 330-a, a first principal account 335-a, and a second principal account 335-b. For example, the first access path permission 302-a may indicate the first principal account 335-a and the second principal account 335-b may be granted read and write access to the first file 325-a. A second access path permission 302-b may affect a second file 325-b, a first file path 330-b, and a third principal account 335-c. For example, the second access path permission 302-b may indicate the third principal account 335-c a may be granted read access to the second file 325-b. Although the listing 300 shows one or more access permissions for two files, a listing may show the access permissions for any quantity of files (e.g., hundreds or thousands of files or resources). Such a listing may be scrollable or searchable.

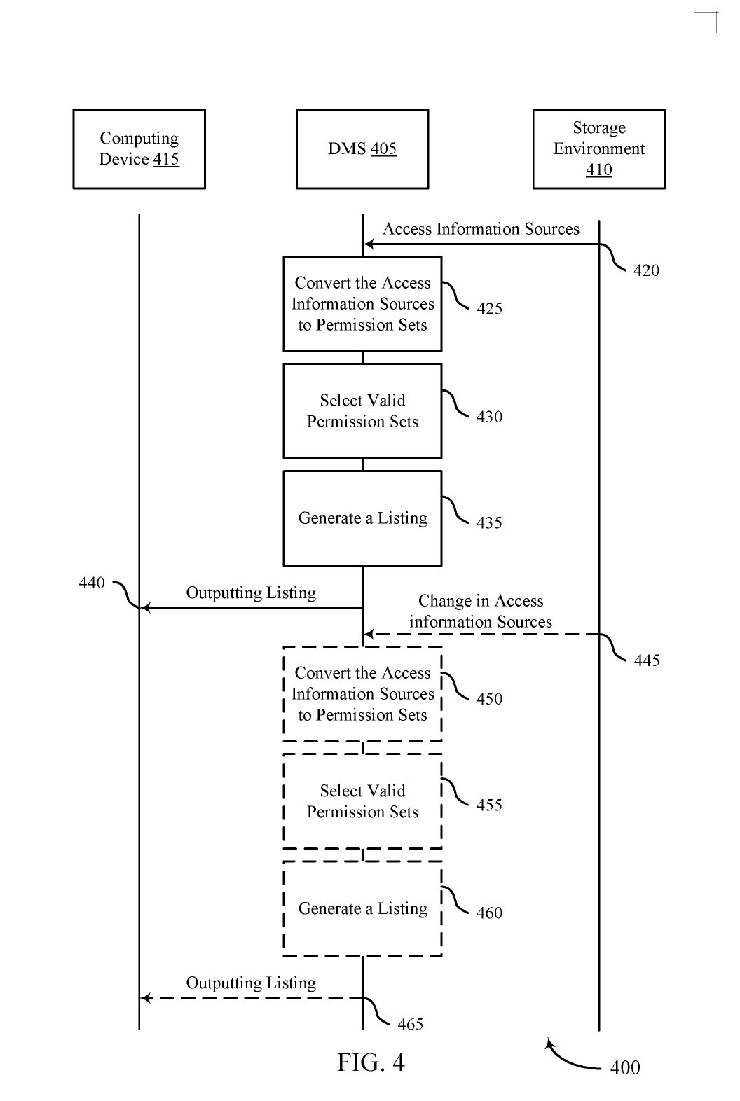

FIG. 4 shows an example of a process flow 400 that supports storage environment access permission normalization in accordance with aspects of the present disclosure. The process flow 400 may implement or be implemented by aspects of FIGs. 1–3. For example, the process flow 400 may be implemented by DMS 405, a storage environment 410, and a computing device 415, which may represent examples of a corresponding DMS, storage environments, and computing devices as described with reference to FIGs. 1–3. In the following description of the process flow 400, operations between the DMS 405. the storage environment 410, and the computing device 415 may be added, omitted, or performed in a different order (with respect to the exemplary order shown).

At 420, the DMS 405 may obtain a set of access information sources including access permission information for one or more principal accounts to access one or more files in a storage environment 410. The storage environment 410 may be accessible to the DMS 405. At least two of the set of access information sources may have different formats. The set of access information sources may include resource-based policies, identity-based policies, permission boundaries, organizational policies, access control lists, or any combination thereof.

At 425, the DMS 405 may convert the set of access information sources to one or more permission sets each having a same format. In some cases, a permission set of the one or more permission sets may include an indication of a set of files, an indication of a set of users, or an access permission of the set of users for the set of files. The set of files may be based on each of the set of files matching a regular expression resource pattern of the permission set.

At 430, the DMS 405 may select one or more valid permission sets from among the one or more permission sets based on respective owner accounts associated with the one or more files, based on the one or more permission sets, and based on the one or more principal accounts. For example, the valid permission sets may be the access path permissions described herein. In some examples, the DMS 405 may apply one or more respective filters corresponding to the one or more permission sets. Selecting the one or more valid permission sets may be based on application of the one or more respective filters to the one or more permission sets. The one or more respective filters may be based on a resource associated with the one or more files, the one or more principal accounts, connection data associated with a request, or any combination thereof.

In some cases, the DMS 405 may omit a first permission set of the one or more permission sets from the listing based on the first permission set contradicting a second permission set of the one or more valid permission sets. For example, the first permission set may contradict the second permission set because the first permission set may grant a principal account of the one or more principal accounts access to a file and the second permission set may deny the principal account access to the file. The first permission set may be associated with the principal account and the second permission set may be associated with a respective owner account for the file. Accordingly, as the second permission set is a same-account permission, the second permission set may overrule the first permission set which may grant cross-account access, and the first permissions set may be omitted (e.g., may be insufficient to grant access).

In some cases, the DMS 405 may omit a first permission of a first permission set of the one or more permission sets associated with a first owner account of the respective owner accounts based on the first permission granting one or more permissions to a file associated with a second owner account of the respective owner accounts. For example, as described herein, a permission set that grants cross-account access (e.g., grants access to a file in a resource set owned by a different owner account than the source of the permission) may be insufficient to grant access to the file absent another permission that grants same-account access (e.g., a permission from the same resource set as the file to which the permission grants access).

In some cases, the DMS 405 may merge a first permission set of the one or more permission sets with a second permission set of the one or more permission sets into a unified permission set based on a first permission of the first permission set and a second permission of the second permission set granting a principal account of the one or more principal accounts access to a file associated with a first owner account from among the respective owner accounts. The first permission set may be associated with the first owner account, and the second permission set may be associated with a second owner account from among the respective owner accounts. For example, a first permission set that grants cross-account access may be merged with a second permission set that grants the same access type to the same principal account and grants same-account access.

In some cases, a permission set of the one or more permission sets may indicate an access permission level. The access permission level may indicate that the one or more principal accounts or a subset of the one or more principal accounts are allowed read access, are allowed write access, are allowed read access and write access, or are denied access to an associated set of files.

At 435, the DMS 405 may generate, based on the one or more valid permission sets, a listing that indicates, for the one or more files, respective sets of principal accounts and associated respective access permission levels.

At 440, the DMS 405 may cause display, via a user interface of a computing device 415 associated with an administrative user of the DMS 405 and for the one or more files, of the respective sets of principal accounts and the associated respective access permission levels (e.g., as illustrated in FIG. 3).

At 445, the DMS 405 may identify, after displaying the listing, an update to one or more access information sources of the set of access information sources. In some examples, the DMS 405 may obtain an indication of a change in one or more access information sources of the set of multiple access information sources.

At 450, the DMS 405 may convert, based on the update, the one or more access information sources to one or more second permission sets each having the same format. In some examples, the DMS 405 may convert, based on the change, the one or more access information sources to one or more second permission sets each having the same format.

At 455, the DMS 405 may one or more second valid permission sets from among the one or more permission sets and the one or more second permission sets based on second respective owner accounts associated with the one or more files after the update, based on the one or more permission sets, based on the one or more second permission sets, based on the one or more principal accounts, and based on the update. In some examples, the DMS 405 may update a subset of the one or more valid permission sets associated with the one or more access information sources based on the one or more second permission sets and based on the change in the one or more access information sources.

At 460, the DMS 405 may generate, based on the one or more second valid permission sets, a second listing that indicates, for the one or more files, second respective sets of user accounts, and second associated respective access permission levels. In some examples, the DMS 405 may update the listing based on updating the subset of the one or more valid permission sets.

At 465, the DMS 405 may cause display, via a user interface of a computing device 415 associated with an administrative user of the DMS 405 and for the one or more files, of the respective sets of principal accounts and the associated updated respective access permission levels (e.g., as illustrated in FIG. 3).

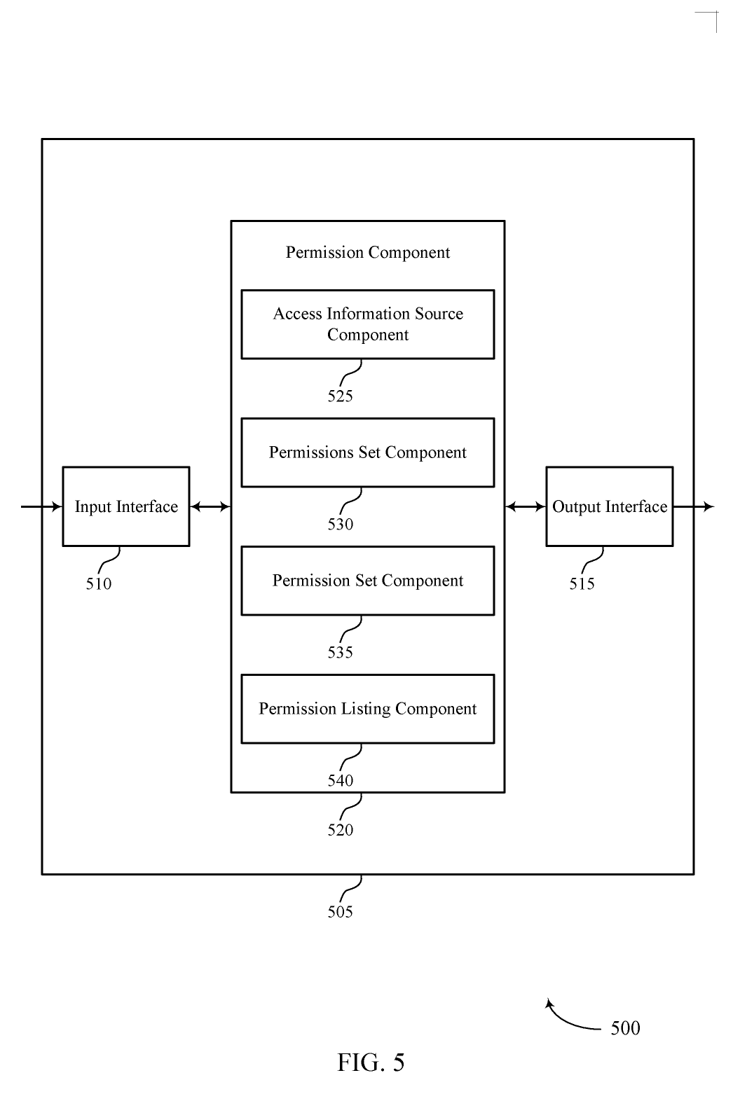

FIG. 5 shows a block diagram 500 of a system 505 that supports storage environment access permission normalization in accordance with aspects of the present disclosure. In some examples, the system 505 may be an example of aspects of one or more components described with reference to FIG. 1, such as a DMS 110. The system 505 may include an input interface 510, an output interface 515, and a permission component 520. The system 505 may also include one or more processors. Each of these components may be in communication with one another (e.g., via one or more buses, communications links, communications interfaces, or any combination thereof).

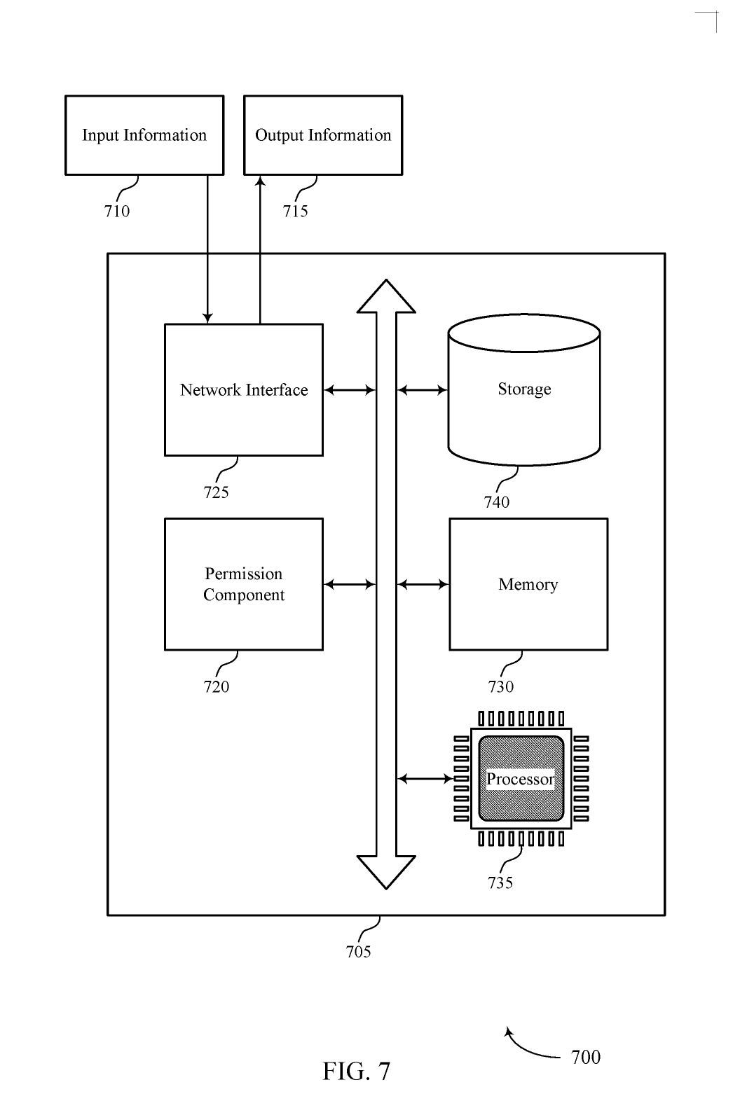

The input interface 510 may manage input signaling for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the permission component 520 to support storage environment access permission normalization. In some cases, the input interface 510 may be a component of a network interface 725 as described with reference to FIG. 7.

The output interface 515 may manage output signaling for the system 505. For example, the output interface 515 may receive signaling from other components of the system 505, such as the permission component 520, and may transmit such output signaling corresponding to (e.g., representative of or otherwise based on) such signaling to other systems or devices. In some cases, the output interface 515 may be a component of a network interface 725 as described with reference to FIG. 7.

For example, the permission component 520 may include an access information source component 525, a permissions set component 530, a permission set component 535, a permission listing component 540, or any combination thereof. In some examples, the permission component 520, or various components thereof, may be configured to perform various operations (e.g., receiving, monitoring, transmitting) using or otherwise in cooperation with the input interface 510, the output interface 515, or both. For example, the permission component 520 may receive information from the input interface 510, send information to the output interface 515, or be integrated in combination with the input interface 510, the output interface 515, or both to receive information, transmit information, or perform various other operations as described herein.

The access information source component 525 may be configured as or otherwise support a means for obtaining, by a DMS, a set of multiple access information sources including access permission information for one or more principal accounts to access one or more files in a storage environment, the storage environment accessible to the DMS, and at least two of the set of multiple access information sources having different formats. The permissions set component 530 may be configured as or otherwise support a means for converting, by the DMS, the set of multiple access information sources to one or more permission sets each having a same format. The permission set component 535 may be configured as or otherwise support a means for selecting, by the DMS, one or more valid permission sets from among the one or more permission sets based on respective owner accounts associated with the one or more files, based on the one or more permission sets, and based on the one or more principal accounts. The permission listing component 540 may be configured as or otherwise support a means for generating, by the DMS and based on the one or more valid permission sets, a listing that indicates, for the one or more files, respective sets of principal accounts and associated respective access permission levels.

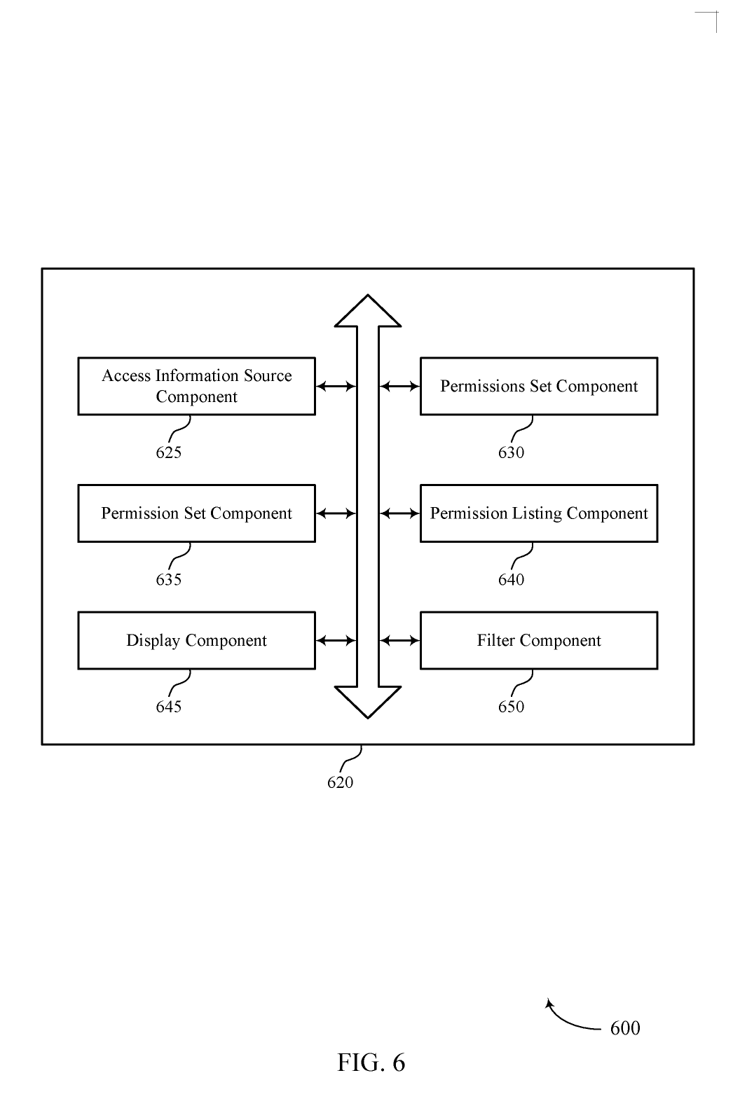

FIG. 6 shows a block diagram 600 of a permission component 620 that supports storage environment access permission normalization in accordance with aspects of the present disclosure. The permission component 620 may be an example of aspects of a permission component or a permission component 520, or both, as described herein. The permission component 620, or various components thereof, may be an example of means for performing various aspects of storage environment access permission normalization as described herein. For example, the permission component 620 may include an access information source component 625, a permissions set component 630, a permission set component 635, a permission listing component 640, a display component 645, a filter component 650, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The access information source component 625 may be configured as or otherwise support a means for obtaining, by a DMS, a set of multiple access information sources including access permission information for one or more principal accounts to access one or more files in a storage environment, the storage environment accessible to the DMS, and at least two of the set of multiple access information sources having different formats. The permissions set component 630 may be configured as or otherwise support a means for converting, by the DMS, the set of multiple access information sources to one or more permission sets each having a same format. The permission set component 635 may be configured as or otherwise support a means for selecting, by the DMS, one or more valid permission sets from among the one or more permission sets based on respective owner accounts associated with the one or more files, based on the one or more permission sets, and based on the one or more principal accounts. The permission listing component 640 may be configured as or otherwise support a means for generating, by the DMS and based on the one or more valid permission sets, a listing that indicates, for the one or more files, respective sets of principal accounts and associated respective access permission levels.

In some examples, the display component 645 may be configured as or otherwise support a means for causing display, via a user interface associated with an administrative user of the DMS and for the one or more files, of the respective sets of principal accounts and the associated respective access permission levels.

In some examples, the access information source component 625 may be configured as or otherwise support a means for identifying, after displaying the listing, an update to one or more access information sources of the set of multiple access information sources.

In some examples, the permission set component 635 may be configured as or otherwise support a means for converting, by the DMS and based on the update, the one or more access information sources to one or more second permission sets each having the same format. In some examples, the permission set component 635 may be configured as or otherwise support a means for selecting, by the DMS, one or more second valid permission sets from among the one or more permission sets and the one or more second permission sets based on second respective owner accounts associated with the one or more files after the update, based on the one or more permission sets, based on the one or more second permission sets, based on the one or more principal accounts, and based on the update. In some examples, the permission listing component 640 may be configured as or otherwise support a means for generating, by the DMS and based on the one or more second valid permission sets, a second listing that indicates, for the one or more files, second respective sets of user accounts and second associated respective access permission levels.

In some examples, the access information source component 625 may be configured as or otherwise support a means for obtaining, by the DMS, an indication of a change in one or more access information sources of the set of multiple access information sources. In some examples, the permission set component 635 may be configured as or otherwise support a means for converting, by the DMS and based on the change, the one or more access information sources to one or more second permission sets each having the same format. In some examples, the permission set component 635 may be configured as or otherwise support a means for updating, by the DMS, a subset of the one or more valid permission sets associated with the one or more access information sources based on the one or more second permission sets and based on the change in the one or more access information sources. In some examples, the permission listing component 640 may be configured as or otherwise support a means for updating, by the DMS, the listing based on updating the subset of the one or more valid permission sets.

In some examples, a permission set of the one or more permission sets includes an indication of a set of files, an indication of a set of users, and an access permission of the set of users for the set of files.

In some examples, the set of files is based on each of the set of files matching a regular expression resource pattern of the permission set.

In some examples, the filter component 650 may be configured as or otherwise support a means for applying one or more respective filters corresponding to the one or more permission sets, where selecting the one or more valid permission sets is based on application of the one or more respective filters to the one or more permission sets.

In some examples, the one or more respective filters are based on a resource associated with the one or more files, the one or more principal accounts, connection data associated with a request, or any combination thereof.

In some examples, to support generating the listing, the permission listing component 640 may be configured as or otherwise support a means for omitting a first permission set of the one or more permission sets from the listing based on the first permission set contradicting a second permission set of the one or more valid permission sets, where the first permission set grants a principal account of the one or more principal accounts access to a file and the second permission set denies the principal account access to the file.

In some examples, the first permission set is associated with the principal account and the second permission set is associated with a respective owner account from among the respective owner accounts.

In some examples, to support selecting the one or more valid permission sets, the permission set component 635 may be configured as or otherwise support a means for omitting a first permission of a first permission set of the one or more permission sets associated with a first owner account of the respective owner accounts based on the first permission granting one or more permissions to a file associated with a second owner account of the respective owner accounts.

In some examples, to support selecting the one or more valid permission sets, the permission set component 635 may be configured as or otherwise support a means for merging a first permission set of the one or more permission sets with a second permission set of the one or more permission sets into a unified permission set based on a first permission of the first permission set and a second permission of the second permission set granting a principal account of the one or more principal accounts access to a file associated with a first owner account from among the respective owner accounts.

In some examples, the first permission set is associated with the first owner account. In some examples, the second permission set is associated with a second owner account from among the respective owner accounts.

In some examples, the set of multiple access information sources include resource-based policies, identity-based policies, permission boundaries, organizational policies, access control lists, or any combination thereof.

In some examples, a permission set of the one or more permission sets indicates an access permission level. In some examples, the access permission level indicates that the one or more principal accounts or a subset of the one or more principal accounts are allowed read access, are allowed write access, are allowed read access and write access, or are denied access to an associated set of files.

FIG. 7 shows a block diagram 700 of a system 705 that supports storage environment access permission normalization in accordance with aspects of the present disclosure. The system 705 may be an example of or include components of a system 505 as described herein. The system 705 may include components for data management, including components such as a permission component 720, an input information 710, an output information 715, a network interface 725, at least one memory 730, at least one processor 735, and a storage 740. These components may be in electronic communication or otherwise coupled with each other (e.g., operatively, communicatively, functionally, electronically, electrically; via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of may be an example of aspects of one or more components described with reference to FIG. 1, such as one or more network interfaces 165.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories 175.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting storage environment access permission normalization). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1, such as one or more processors 170.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1, such as one or more network disks 180.

For example, the permission component 720 may be configured as or otherwise support a means for obtaining, by a DMS, a set of multiple access information sources including access permission information for one or more principal accounts to access one or more files in a storage environment, the storage environment accessible to the DMS, and at least two of the set of multiple access information sources having different formats. The permission component 720 may be configured as or otherwise support a means for converting, by the DMS, the set of multiple access information sources to one or more permission sets each having a same format. The permission component 720 may be configured as or otherwise support a means for selecting, by the DMS, one or more valid permission sets from among the one or more permission sets based on respective owner accounts associated with the one or more files, based on the one or more permission sets, and based on the one or more principal accounts. The permission component 720 may be configured as or otherwise support a means for generating, by the DMS and based on the one or more valid permission sets, a listing that indicates, for the one or more files, respective sets of principal accounts and associated respective access permission levels.

By including or configuring the permission component 720 in accordance with examples as described herein, the system 705 may support techniques for storage environment access permission normalization, which may provide one or more benefits such as, for example, improved user experience and more efficient utilization of computing resources, among other possibilities.

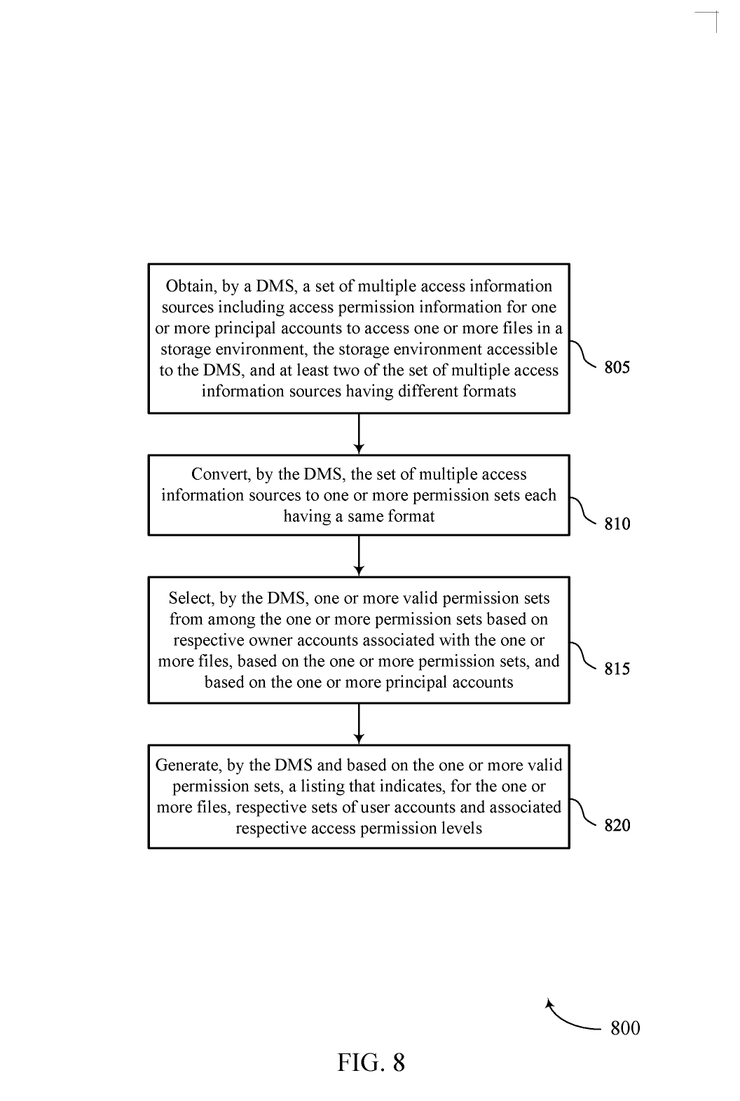

FIG. 8 shows a flowchart illustrating a method 800 that supports storage environment access permission normalization in accordance with aspects of the present disclosure. The operations of the method 800 may be implemented by a DMS or its components as described herein. For example, the operations of the method 800 may be performed by a DMS as described with reference to. FIGS. 1 through 7. In some examples, a DMS may execute a set of instructions to control the functional elements of the DMS to perform the described functions. Additionally, or alternatively, the DMS may perform aspects of the described functions using special-purpose hardware.

At 805, the method may include obtaining, by a DMS, a set of multiple access information sources including access permission information for one or more principal accounts to access one or more files in a storage environment, the storage environment accessible to the DMS, and at least two of the set of multiple access information sources having different formats. The operations of 805 may be performed in accordance with examples as disclosed herein. In some examples, aspects of the operations of 805 may be performed by an access information source component 625 as described with reference to FIG. 6.

At 810, the method may include converting, by the DMS, the set of multiple access information sources to one or more permission sets each having a same format. The operations of 810 may be performed in accordance with examples as disclosed herein. In some examples, aspects of the operations of 810 may be performed by a permissions set component 630 as described with reference to FIG. 6.

At 815, the method may include selecting, by the DMS, one or more valid permission sets from among the one or more permission sets based on respective owner accounts associated with the one or more files, based on the one or more permission sets, and based on the one or more principal accounts. The operations of 815 may be performed in accordance with examples as disclosed herein. In some examples, aspects of the operations of 815 may be performed by a permission set component 635 as described with reference to FIG. 6.

At 820, the method may include generating, by the DMS and based on the one or more valid permission sets, a listing that indicates, for the one or more files, respective sets of principal accounts and associated respective access permission levels. The operations of 820 may be performed in accordance with examples as disclosed herein. In some examples, aspects of the operations of 820 may be performed by a permission listing component 640 as described with reference to FIG. 6.

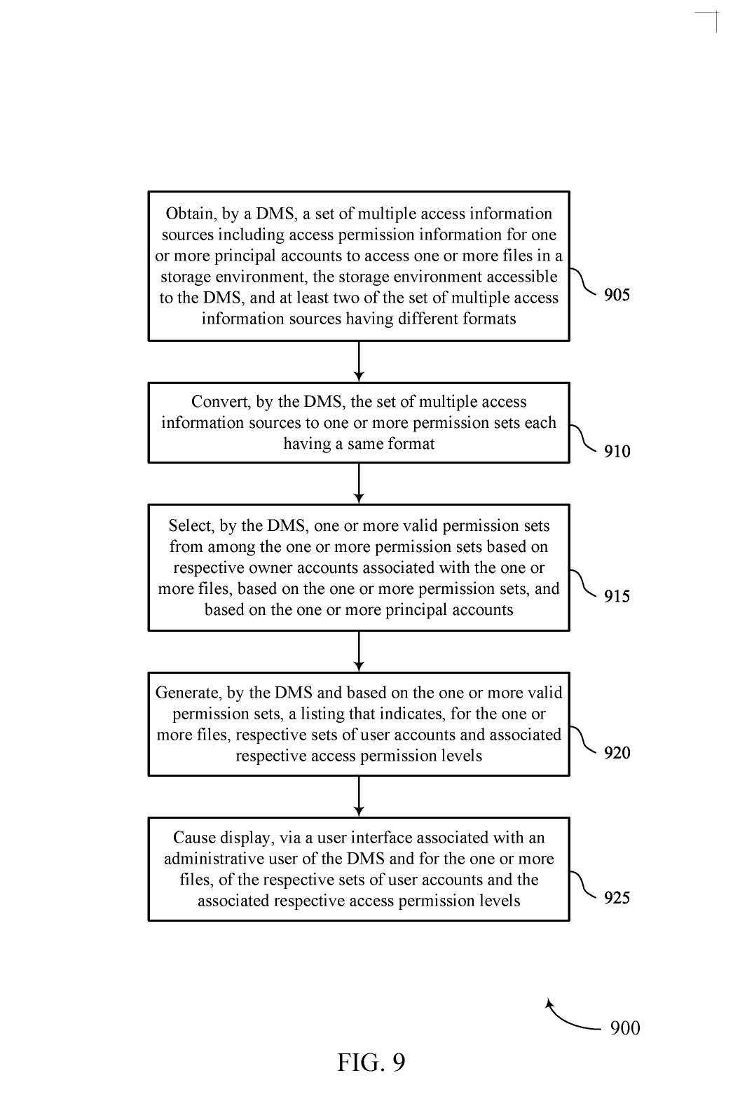

FIG. 9 shows a flowchart illustrating a method 900 that supports storage environment access permission normalization in accordance with aspects of the present disclosure. The operations of the method 900 may be implemented by a DMS or its components as described herein. For example, the operations of the method 900 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 905, the method may include obtaining, by a DMS, a set of multiple access information sources including access permission information for one or more principal accounts to access one or more files in a storage environment, the storage environment accessible to the DMS, and at least two of the set of multiple access information sources having different formats. The operations of 905 may be performed in accordance with examples as disclosed herein. In some examples, aspects of the operations of 905 may be performed by an access information source component 625 as described with reference to FIG. 6.

At 910, the method may include converting, by the DMS, the set of multiple access information sources to one or more permission sets each having a same format. The operations of 910 may be performed in accordance with examples as disclosed herein. In some examples, aspects of the operations of 910 may be performed by a permissions set component 630 as described with reference to FIG. 6.

At 915, the method may include selecting, by the DMS, one or more valid permission sets from among the one or more permission sets based on respective owner accounts associated with the one or more files, based on the one or more permission sets, and based on the one or more principal accounts. The operations of 915 may be performed in accordance with examples as disclosed herein. In some examples, aspects of the operations of 915 may be performed by a permission set component 635 as described with reference to FIG. 6.

At 920, the method may include generating, by the DMS and based on the one or more valid permission sets, a listing that indicates, for the one or more files, respective sets of principal accounts and associated respective access permission levels. The operations of 920 may be performed in accordance with examples as disclosed herein. In some examples, aspects of the operations of 920 may be performed by a permission listing component 640 as described with reference to FIG. 6.

At 925, the method may include causing display, via a user interface associated with an administrative user of the DMS and for the one or more files, of the respective sets of principal accounts and the associated respective access permission levels. The operations of 925 may be performed in accordance with examples as disclosed herein. In some examples, aspects of the operations of 925 may be performed by a display component 645 as described with reference to FIG. 6.

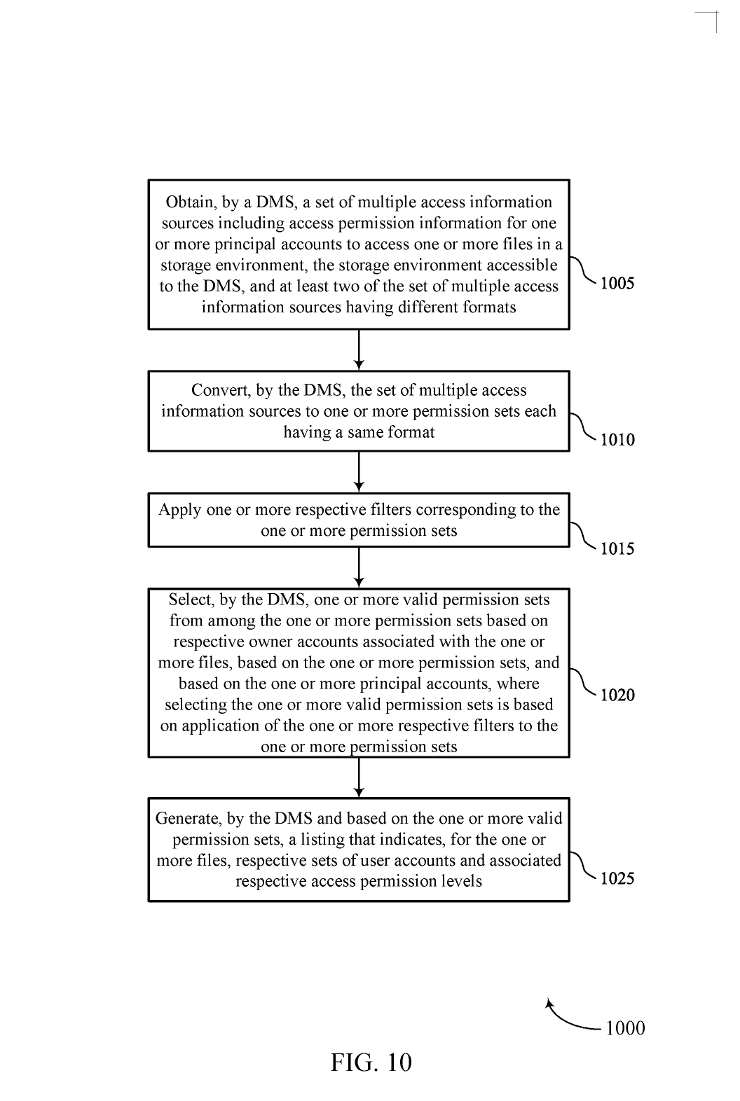

FIG. 10 shows a flowchart illustrating a method 1000 that supports storage environment access permission normalization in accordance with aspects of the present disclosure. The operations of the method 1000 may be implemented by a DMS or its components as described herein. For example, the operations of the method 1000 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 1005, the method may include obtaining, by a DMS, a set of multiple access information sources including access permission information for one or more principal accounts to access one or more files in a storage environment, the storage environment accessible to the DMS, and at least two of the set of multiple access information sources having different formats. The operations of 1005 may be performed in accordance with examples as disclosed herein. In some examples, aspects of the operations of 1005 may be performed by an access information source component 625 as described with reference to FIG. 6.

At 1010, the method may include converting, by the DMS, the set of multiple access information sources to one or more permission sets each having a same format. The operations of 1010 may be performed in accordance with examples as disclosed herein. In some examples, aspects of the operations of 1010 may be performed by a permissions set component 630 as described with reference to FIG. 6.

At 1015, the method may include applying one or more respective filters corresponding to the one or more permission sets. The operations of 1015 may be performed in accordance with examples as disclosed herein. In some examples, aspects of the operations of 1015 may be performed by a filter component 650 as described with reference to FIG. 6.

At 1020, the method may include selecting, by the DMS, one or more valid permission sets from among the one or more permission sets based on respective owner accounts associated with the one or more files, based on the one or more permission sets, and based on the one or more principal accounts. Selecting the one or more valid permission sets is based on application of the one or more respective filters to the one or more permission sets. The operations of 1020 may be performed in accordance with examples as disclosed herein. In some examples, aspects of the operations of 1020 may be performed by a permission set component 635 as described with reference to FIG. 6.

At 1025, the method may include generating, by the DMS and based on the one or more valid permission sets, a listing that indicates, for the one or more files, respective sets of principal accounts and associated respective access permission levels. The operations of 1025 may be performed in accordance with examples as disclosed herein. In some examples, aspects of the operations of 1025 may be performed by a permission listing component 640 as described with reference to FIG. 6.

The following provides an overview of aspects of the present disclosure:

Aspect 1: A method, comprising: obtaining, by a DMS, a plurality of access information sources comprising access permission information for one or more principal accounts to access one or more files in a storage environment, the storage environment accessible to the DMS, and at least two of the plurality of access information sources having different formats; converting, by the DMS, the plurality of access information sources to one or more permission sets each having a same format; selecting, by the DMS, one or more valid permission sets from among the one or more permission sets based at least in part on respective owner accounts associated with the one or more files, based at least in part on the one or more permission sets, and based at least in part on the one or more principal accounts; and generating, by the DMS and based at least in part on the one or more valid permission sets, a listing that indicates, for the one or more files, respective sets of principal accounts and associated respective access permission levels.

Aspect 2: The method of aspect 1, further comprising: causing display, via a user interface associated with an administrative user of the DMS and for the one or more files, of the respective sets of principal accounts and the associated respective access permission levels.

Aspect 3: The method of aspect 2, further comprising: identifying, after displaying the listing, an update to one or more access information sources of the plurality of access information sources.

Aspect 4: The method of aspect 3, further comprising: converting, by the DMS and based at least in part on the update, the one or more access information sources to one or more second permission sets each having the same format; selecting, by the DMS, one or more second valid permission sets from among the one or more permission sets and the one or more second permission sets based at least in part on second respective owner accounts associated with the one or more files after the update, based at least in part on the one or more permission sets, based at least in part on the one or more second permission sets, based at least in part on the one or more principal accounts, and based at least in part on the update; and generating, by the DMS and based at least in part on the one or more second valid permission sets, a second listing that indicates, for the one or more files, second respective sets of user accounts and second associated respective access permission levels.

Aspect 5: The method of any of aspects 1 through 4, further comprising: obtaining, by the DMS, an indication of a change in one or more access information sources of the plurality of access information sources; converting, by the DMS and based at least in part on the change, the one or more access information sources to one or more second permission sets each having the same format; updating, by the DMS, a subset of the one or more valid permission sets associated with the one or more access information sources based at least in part on the one or more second permission sets and based at least in part on the change in the one or more access information sources; and updating, by the DMS, the listing based at least in part on updating the subset of the one or more valid permission sets.

Aspect 6: The method of any of aspects 1 through 5, wherein a permission set of the one or more permission sets comprises an indication of a set of files, an indication of a set of users, and an access permission of the set of users for the set of files.

Aspect 7: The method of aspect 6, wherein the set of files is based at least in part on each of the set of files matching a regular expression resource pattern of the permission set.

Aspect 8: The method of any of aspects 1 through 7, further comprising: applying one or more respective filters corresponding to the one or more permission sets, wherein selecting the one or more valid permission sets is based at least in part on application of the one or more respective filters to the one or more permission sets.

Aspect 9: The method of aspect 8, wherein the one or more respective filters are based at least in part on a resource associated with the one or more files, the one or more principal accounts, connection data associated with a request, or any combination thereof.

Aspect 10: The method of any of aspects 1 through 9, wherein generating the listing comprises: omitting a first permission set of the one or more permission sets from the listing based at least in part on the first permission set contradicting a second permission set of the one or more valid permission sets, wherein the first permission set grants a principal account of the one or more principal accounts access to a file and the second permission set denies the principal account access to the file.

Aspect 11: The method of aspect 10, wherein the first permission set is associated with the principal account and the second permission set is associated with a respective owner account from among the respective owner accounts.

Aspect 12: The method of any of aspects 1 through 9, wherein selecting the one or more valid permission sets comprises: omitting a first permission of a first permission set of the one or more permission sets associated with a first owner account of the respective owner accounts based at least in part on the first permission granting one or more permissions to a file associated with a second owner account of the respective owner accounts.

Aspect 13: The method of any of aspects 1 through 12, wherein selecting the one or more valid permission sets comprises: merging a first permission set of the one or more permission sets with a second permission set of the one or more permission sets into a unified permission set based at least in part on a first permission of the first permission set and a second permission of the second permission set granting a principal account of the one or more principal accounts access to a file associated with a first owner account from among the respective owner accounts.

Aspect 14: The method of aspect 13, wherein the first permission set is associated with the first owner account, and the second permission set is associated with a second owner account from among the respective owner accounts.

Aspect 15: The method of any of aspects 1 through 14, wherein the plurality of access information sources comprise resource-based policies, identity-based policies, permission boundaries, organizational policies, access control lists, or any combination thereof.

Aspect 16: The method of any of aspects 1 through 15, wherein a permission set of the one or more permission sets indicates an access permission level, and the access permission level indicates that the one or more principal accounts or a subset of the one or more principal accounts are allowed read access, are allowed write access, are allowed read access and write access, or are denied access to an associated set of files.

Aspect 17: An apparatus comprising one or more memories storing processor-executable code, and one or more processors coupled with the one or more memories and individually or collectively operable to execute the code to cause the apparatus to perform a method of any of aspects 1 through 16.

Aspect 18: An apparatus comprising at least one means for performing a method of any of aspects 1 through 16.

Aspect 19: A non-transitory computer-readable medium storing code the code comprising instructions executable by one or more processors to perform a method of any of aspects 1 through 16.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
obtaining, by a data management system (DMS), a plurality of access information sources comprising access permission information for one or more principal accounts to access one or more files in a storage environment, the storage environment accessible to the DMS, and at least two of the plurality of access information sources having different formats;
converting, by the DMS, the plurality of access information sources to one or more permission sets each having a same format;
selecting, by the DMS, one or more valid permission sets from among the one or more permission sets based at least in part on respective owner accounts associated with the one or more files, based at least in part on the one or more permission sets, and based at least in part on the one or more principal accounts; and
generating, by the DMS and based at least in part on the one or more valid permission sets, a listing that indicates, for the one or more files, respective sets of principal accounts and associated respective access permission levels.

2. The method of claim 1, further comprising:
causing display, via a user interface associated with an administrative user of the DMS and for the one or more files, of the respective sets of principal accounts and the associated respective access permission levels.

3. The method of claim 2, further comprising:
identifying, after displaying the listing, an update to one or more access information sources of the plurality of access information sources.

4. The method of claim 3, further comprising:
converting, by the DMS and based at least in part on the update, the one or more access information sources to one or more second permission sets each having the same format;
selecting, by the DMS, one or more second valid permission sets from among the one or more permission sets and the one or more second permission sets based at least in part on second respective owner accounts associated with the one or more files after the update, based at least in part on the one or more permission sets, based at least in part on the one or more second permission sets, based at least in part on the one or more principal accounts, and based at least in part on the update; and
generating, by the DMS and based at least in part on the one or more second valid permission sets, a second listing that indicates, for the one or more files, second respective sets of user accounts and second associated respective access permission levels.

5. The method of claim 1, further comprising:
obtaining, by the DMS, an indication of a change in one or more access information sources of the plurality of access information sources;
converting, by the DMS and based at least in part on the change, the one or more access information sources to one or more second permission sets each having the same format;
updating, by the DMS, a subset of the one or more valid permission sets associated with the one or more access information sources based at least in part on the one or more second permission sets and based at least in part on the change in the one or more access information sources; and
updating, by the DMS, the listing based at least in part on updating the subset of the one or more valid permission sets.

6. The method of claim 1, wherein a permission set of the one or more permission sets comprises an indication of a set of files, an indication of a set of users, and an access permission of the set of users for the set of files.

7. The method of claim 6, wherein the set of files is based at least in part on each of the set of files matching a regular expression resource pattern of the permission set.

8. The method of claim 1, further comprising:
applying one or more respective filters corresponding to the one or more permission sets, wherein selecting the one or more valid permission sets is based at least in part on application of the one or more respective filters to the one or more permission sets.

9. The method of claim 8, wherein the one or more respective filters are based at least in part on a resource associated with the one or more files, the one or more principal accounts, connection data associated with a request, or any combination thereof.

10. The method of claim 1, wherein generating the listing comprises:
omitting a first permission set of the one or more permission sets from the listing based at least in part on the first permission set contradicting a second permission set of the one or more valid permission sets, wherein the first permission set grants a principal account of the one or more principal accounts access to a file and the second permission set denies the principal account access to the file.

11. The method of claim 10, wherein the first permission set is associated with the principal account and the second permission set is associated with a respective owner account from among the respective owner accounts.

12. The method of claim 1, wherein selecting the one or more valid permission sets comprises:
omitting a first permission of a first permission set of the one or more permission sets associated with a first owner account of the respective owner accounts based at least in part on the first permission granting one or more permissions to a file associated with a second owner account of the respective owner accounts.

13. The method of claim 1, wherein selecting the one or more valid permission sets comprises:
merging a first permission set of the one or more permission sets with a second permission set of the one or more permission sets into a unified permission set based at least in part on a first permission of the first permission set and a second permission of the second permission set granting a principal account of the one or more principal accounts access to a file associated with a first owner account from among the respective owner accounts.

14. The method of claim 13, wherein:
the first permission set is associated with the first owner account, and
the second permission set is associated with a second owner account from among the respective owner accounts.

15. The method of claim 1, wherein the plurality of access information sources comprise resource-based policies, identity-based policies, permission boundaries, organizational policies, access control lists, or any combination thereof.

16. The method of claim 1, wherein:
a permission set of the one or more permission sets indicates an access permission level, and
the access permission level indicates that the one or more principal accounts or a subset of the one or more principal accounts are allowed read access, are allowed write access, are allowed read access and write access, or are denied access to an associated set of files.

17. An apparatus, comprising:
one or more memories storing processor-executable code; and
one or more processors coupled with the one or more memories and individually or collectively operable to execute the code to cause the apparatus to:
obtain, by a data management system (DMS), a plurality of access information sources comprising access permission information for one or more principal accounts to access one or more files in a storage environment, the storage environment accessible to the DMS, and at least two of the plurality of access information sources having different formats;
convert, by the DMS, the plurality of access information sources to one or more permission sets each having a same format;
select, by the DMS, one or more valid permission sets from among the one or more permission sets based at least in part on respective owner accounts associated with the one or more files, based at least in part on the one or more permission sets, and based at least in part on the one or more principal accounts; and
generate, by the DMS and based at least in part on the one or more valid permission sets, a listing that indicates, for the one or more files, respective sets of principal accounts and associated respective access permission levels.

18. The apparatus of claim 17, wherein the one or more processors are individually or collectively further operable to execute the code to cause the apparatus to:
cause display, via a user interface associated with an administrative user of the DMS and for the one or more files, of the respective sets of principal accounts and the associated respective access permission levels.

19. The apparatus of claim 17, wherein the one or more processors are individually or collectively further operable to execute the code to cause the apparatus to:
obtain, by the DMS, an indication of a change in one or more access information sources of the plurality of access information sources;
convert, by the DMS and based at least in part on the change, the one or more access information sources to one or more second permission sets each having the same format;
update, by the DMS, a subset of the one or more valid permission sets associated with the one or more access information sources based at least in part on the one or more second permission sets and based at least in part on the change in the one or more access information sources; and
update, by the DMS, the listing based at least in part on updating the subset of the one or more valid permission sets.

20. A non-transitory computer-readable medium storing code, the code comprising instructions executable by one or more processors to:
obtain, by a data management system (DMS), a plurality of access information sources comprising access permission information for one or more principal accounts to access one or more files in a storage environment, the storage environment accessible to the DMS, and at least two of the plurality of access information sources having different formats;
convert, by the DMS, the plurality of access information sources to one or more permission sets each having a same format;
select, by the DMS, one or more valid permission sets from among the one or more permission sets based at least in part on respective owner accounts associated with the one or more files, based at least in part on the one or more permission sets, and based at least in part on the one or more principal accounts; and
generate, by the DMS and based at least in part on the one or more valid permission sets, a listing that indicates, for the one or more files, respective sets of principal accounts and associated respective access permission levels.
